(19) United States
(12) Patent Application Publication
(10) Pub. No.: US 2025/0121594 A1
(43) Pub. Date: Apr. 17, 2025

(54) HEATING DRUM FOR THERMAL TRANSFER AND METHOD FOR MANUFACTURING THE SAME

(71) Applicant: KYUNGIL-TECH CO., LTD., SeoGyeongsangnam-do (KR)

(72) Inventors: Soontae JUNG, Gyeongsangnam-do (KR); Sangmin LEE, Gyeongsangnam-do (KR); Hyejin LEE, Gyeongsangnam-do (KR)

(21) Appl. No.: 18/539,405

(22) PCT Filed: Jun. 2, 2022
(86) PCT No.: PCT/KR2022/007856

§ 371 Date: Dec. 14, 2023

(30) Foreign Application Priority Data
Jun. 15, 2021 (KR) 10-2021-0077183

(51) Int. Cl. B41F 31/00; B41F 16/00; B41F 31/03

(52) U.S. Cl. CPC B41F 31/002; B41F 16/0093; B41F 31/03

(57) ABSTRACT

A heating drum for thermal transfer includes: a cylindrical outer tube; an inner tube having a smaller diameter than the outer tube, and disposed inside the outer tube; a rotating shaft fixed to the center of the inner tube via connecting members; covers configured to form a heat transfer oil accommodating space by sealing a space between the inner tube and the outer tube that is opened to the outside; heaters installed to pass through the covers, and configured to heat the sealed heat transfer oil accommodating space; holders disposed between the inner tube and the outer tube, and configured to support the heaters; a valve configured to control the discharge of the internal air of the heat transfer oil accommodating space; and heat transfer oil filled in the heat transfer oil accommodating space.

### BACKGROUND

The present invention relates to a heating drum for thermal transfer and a method for manufacturing the same, and more particularly to a heating drum for thermal transfer that allows heat to be uniformly transferred to heat transfer oil through smooth stirring, achieves the compactness and weight reduction of the heating drum, and can prevent the oxidation of heat transfer oil.

Thermal transfer presses for realizing various colors have an indirect-type transfer structure in which a film-shaped ribbon (or paper for sublimation transfer) coated with ink is located between a thermal recording head (a kind of drum) and a fabric, which is a print target, and thus the ink sublimated in a predetermined pattern by the thermal recording head is transferred to the paper.

FIG. 13 is a conceptual diagram showing a conventional heating drum for thermal transfer. The heating drum for thermal transfer includes a main shaft 210 configured to be rotated by an external drive motor, a cylindrical body 220 coupled to the main shaft 210, an inner tube 230 coupled to the inside of the cylindrical body 220 and configured to form an oil accommodating space B, an inlet 211 formed in the main shaft 210 to be connected to the oil accommodating space B, heaters 240 inserted into the oil accommodating space B at regular intervals, an oil tank 250 interconnected with the inlet 211 and provided with an open top, and oil 260 filled in the oil accommodating space B and the oil tank 250 and configured to be heated by the heaters 240 and to be exposed to the outside through the oil tank 250.

In the case of the conventional heating drum for thermal transfer, when the heaters 240 are heated in the state in which the oil 260 is tightly and fully filled in the oil accommodating space B, the oil 260 thermally expands as the temperature of the oil 260 is increased by the heaters 240. Since the oil tank 250 absorbs this thermal expansion (a change in oil level: h), the heating drum can be protected from damage (rupture) attributable to thermal expansion.

However, the oil tank 250 causes the oxidation of the oil 260 as the oil 260 is exposed to the outside through the top and comes into contact with air. Due to this, the life cycle of the oil 260 is shortened, so that there is the inconvenience of replacing the oil at regular intervals.

In the case of the conventional heating drum for thermal transfer, the oil 260 is tightly and fully filled in the oil accommodating space B, so that, when the heating drum is initially rotated, the oil 260 is stirred by the heaters 240 due to internal friction. Thereafter, the heating drum and the oil 260 are rotated together, so that there is a problem in that the stirring of the oil 260 through the heaters 240 is not performed at all.

In addition, supports for supporting the heaters 240 partition and block the inside of the oil accommodating space B, so that it is difficult to expect the free flow of the oil 260, and thus it is considerably difficult to uniformly adjust the temperature.

As another conventional technology, there is Korean Patent No. 10-0996493 (entitled “Thermal Transfer Drum Device using Heat Transfer Oil”). The overall structure thereof is the same as the above-described structure, except that a plurality of stirring blades are formed on the outer circumferential surface of the inner tube 230 and the oil tank is omitted.

Meanwhile, in this conventional technology, during the initial rotation of the heating drum, the stirring and mixing of the heat transfer oil by the stirring blades are performed desirably, as in the previously described conventional technology.

However, in the preceding patent, the heat transfer oil is tightly and fully filled in the heat transfer oil accommodating space, so that the heating drum and the heat transfer oil are rotated together after a predetermined period of time. For this reason, the stirring of the heat transfer oil through the heaters 240 and the stirring blades is not performed at all.

Furthermore, in the preceding patent, the supports for supporting the heaters also partition and block the inside of the heat transfer oil accommodating space, so that it is difficult to expect the free flow of the heat transfer oil.

Therefore, the heat transferred through the heaters is not uniformly transferred to the heat transfer oil, so that it is considerably difficult to maintain a uniform temperature, which acts as a disadvantage in that the defect rate increases in a product manufacturing process.

Finally, in the case of the preceding patent technology, when the heat transfer oil is heated by the heaters in the state in which the heat transfer oil is tightly and fully filled in the heat transfer oil accommodating space, the heat transfer oil expands thermally during a heating process. Accordingly, the heating drum may be damaged (ruptured), so that it is necessary to apply thick members in the manufacture of the heating drum by taking into consideration the above problem. Therefore, there is a fundamental problem in that it is difficult to achieve the compactness and weight reduction of the heating drum.

### SUMMARY OF THE INVENTION

The present invention has been conceived to overcome the above-described problems, and an object of the present invention is to provide a heating drum for thermal transfer that allows heat to be uniformly transferred to heat transfer oil through smooth stirring, achieves the compactness and weight reduction of the heating drum, and can prevent the oxidation of heat transfer oil.

Another object of the present invention is to provide a method of manufacturing a heating drum for thermal transfer.

In order to accomplish the above object, the present invention provides a heating drum for thermal transfer, the heating drum including:
a cylindrical outer tube;
an inner tube having a smaller diameter than the outer tube, and disposed inside the outer tube;
a rotating shaft fixed to the center of the inner tube via connecting members;
covers configured to form a heat transfer oil accommodating space by sealing a space between the inner tube and the outer tube that is opened to the outside;
heaters installed to pass through the covers, and configured to heat the sealed heat transfer oil accommodating space;
holders disposed between the inner tube and the outer tube, and configured to support the heaters;
a valve configured to control the discharge of the internal air of the heat transfer oil accommodating space; and
heat transfer oil filled in the heat transfer oil accommodating space;
wherein the heat transfer oil is partially filled in the heat transfer oil accommodating space, and the internal air of the heat transfer oil accommodating space is forcibly discharged through the valve so that the internal pressure of the heat transfer oil accommodating space is maintained at a pressure lower than atmospheric pressure.

Furthermore, in the present invention:
stirring blades are provided on the outer circumferential surface of the inner tube in a supplementary manner; and
the heaters are located between the inner circumferential surface of the outer tube and the top surfaces of the stirring blades.

Furthermore, in the present invention:
the holders are installed on the inner tube to be spaced apart from the inner circumferential surface of the outer tube.

Furthermore, in the present invention:
the holders are provided with communication holes in a supplementary manner.

Furthermore, in the present invention:
the length of the outer tube is formed to be longer than the length of the inner tube;
the inner tube is sealed by the connecting members;
auxiliary tubes having a smaller diameter than the inner tube are provided on the connecting members in a complementary manner, and are disposed between the outer tube and the rotating shaft; and
the covers are inserted between the outer tube and the auxiliary tubes, and form a loss compensation space communicating with the heat transfer oil accommodating space while sealing both ends of the outer tube.

Furthermore, in the present invention:
reinforcing plates configured to support the inner tube and the auxiliary tubes are provided in the inner tube and the auxiliary tubes with the connecting members interposed therebetween.

In order to accomplish the other object, the present invention provides a method of manufacturing a heating drum for thermal transfer, the method including:
a heating drum manufacturing step (St1) of disposing an inner tube having a smaller diameter than a cylindrical outer tube inside the outer tube, locating a rotating shaft through the center of the inner tube via connecting members, installing covers having an inlet between the inner tube and the outer tube and performing sealing so that a heat transfer oil accommodating space can be formed in a space between the inner tube and the outer tube, installing heaters to penetrate the covers in order to heat the heat transfer oil accommodating space, installing holders for supporting the heaters between the inner tube and the outer tube, and installing a valve for controlling the discharge of the internal air of the heat transfer oil accommodating space in one of the covers;
an injection and closing step (St2) of injecting heat transfer oil through the inlet formed in the cover so that a portion of the heat transfer oil accommodating space is filled with the heat transfer oil, allowing the internal air of the heat transfer oil accommodating space to be discharged through the valve, and then closing the inlet; and
a negative pressure forming step (St3) of, in the state in which a vacuum pump is connected to the valve, forcibly discharging the internal air of the heat transfer oil accommodating space, and then closing the valve so that the inside of the heat transfer oil accommodating space can be maintained in a state of negative pressure lower than atmospheric pressure.

Furthermore, in the present invention:
in the heating drum manufacturing step (St1), stirring blades are installed on the outer circumferential surface of the inner tube so that the heaters are located between the inner circumferential surface of the outer tube and the top surfaces of the stirring blades.

The present invention may help to keep the overall temperature of the heating drum uniform because the heat transfer oil is directly heated by the heaters and heat is uniformly transferred to the heat transfer oil through smooth stirring, thereby significantly reducing the product defect rate attributable to a difference in temperature.

In addition, the heat transfer oil accommodating space in which the heat transfer oil is accommodated is caused to be in a state of pressure lower than atmospheric pressure, so that expansion can be sufficiently absorbed even when the heat transfer oil is expanded by the heat of the heaters, with the result that the risk of damage or explosion of the heating drum attributable to a change in pressure may be significantly reduced. Accordingly, thin members may be used, so that the compactness and weight reduction of the heating drum can be achieved.

Furthermore, as the heat transfer oil is stored in the heat transfer oil accommodating space in a sealed state, contact with the atmosphere (the outside air) may be fundamentally blocked, so that the oxidation of the heat transfer oil can be prevented.

Moreover, the stirring blades are provided on the outer circumferential surface of the inner tube in a supplementary manner, so that the heat transfer oil can be stirred throughout the overall range thereof, with the result that this can help to maintain the overall temperature of the heating drum rapidly, smoothly and uniformly. Accordingly, the product defect rate attributable to a difference in temperature may be significantly reduced.

### BRIEF DESCRIPTION OF DRAWINGS

FIG. 1 is a perspective view of a heating drum for thermal transfer according to a first embodiment of the present invention;

FIG. 2 is a partial sectional perspective view of FIG. 1;

FIG. 3 is a side sectional view of FIG. 1;

FIG. 4 is a front sectional view of FIG. 1;

FIG. 5 is an enlarged view of portion “A” of FIG. 3;

FIG. 6 is an enlarged view of portion “B” of FIG. 4;

FIGS. 7 and 8 are views illustrating the operation of the heating drum for thermal transfer according to the first embodiment of the present invention;

FIG. 9 is a partial sectional perspective view of a heating drum for thermal transfer according to a second embodiment of the present invention;

FIG. 10 is a side sectional view of the heating drum for thermal transfer according to the second embodiment of the present invention;

FIG. 11 is an enlarged view of portion “D” of FIG. 10;

FIG. 12 is a view illustrating the operation of the heating drum for thermal transfer according to the second embodiment of the present invention; and

FIG. 13 is a conceptual diagram showing a conventional heating drum for thermal transfer.

### DETAILED DESCRIPTION OF THE INVENTION

The present invention will be described in detail below based on the accompanying drawings.

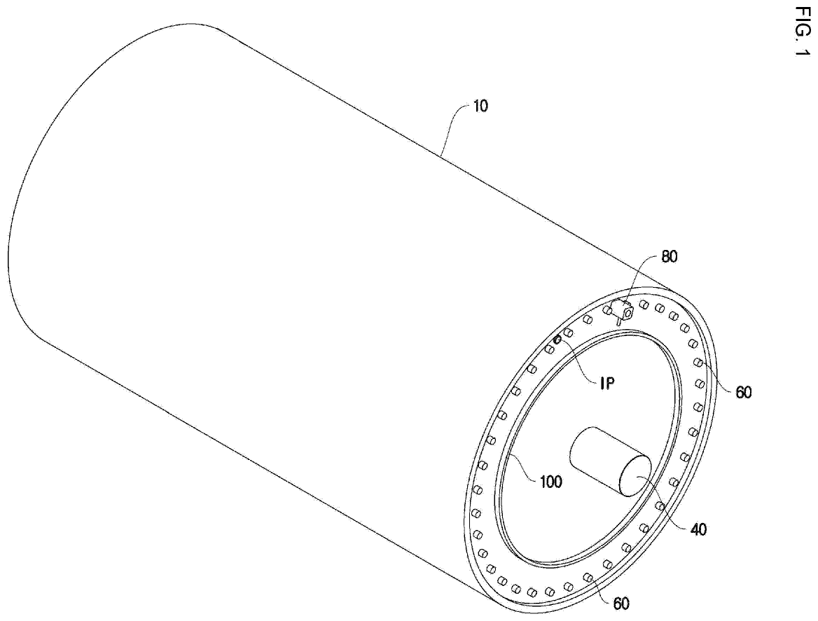

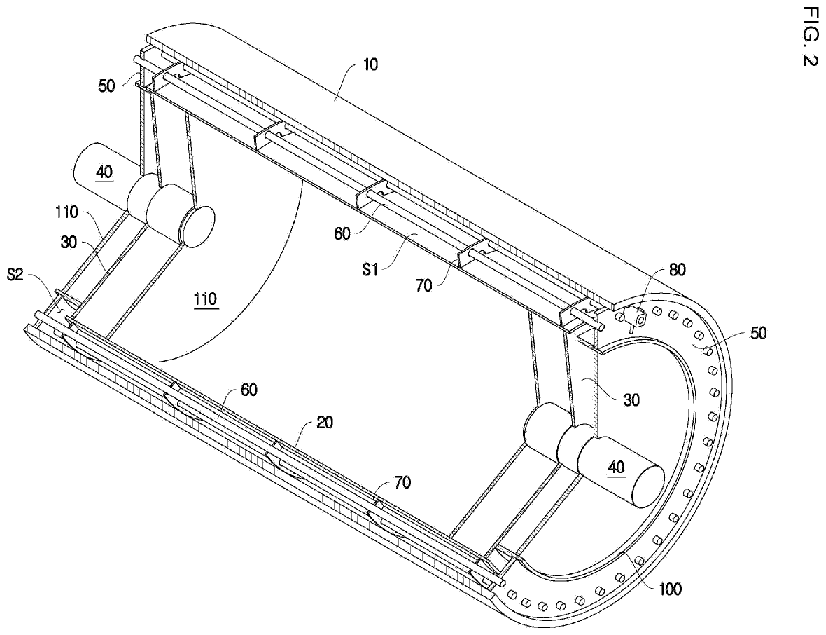

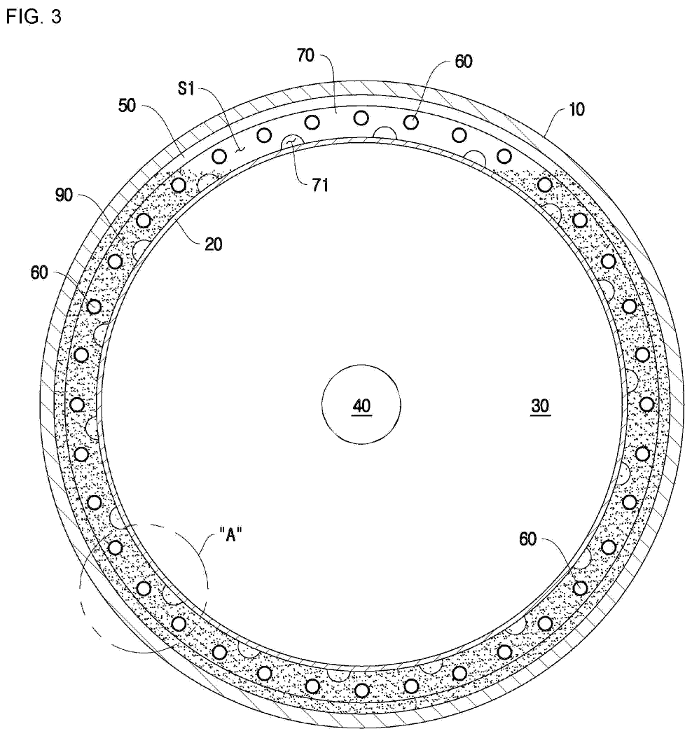

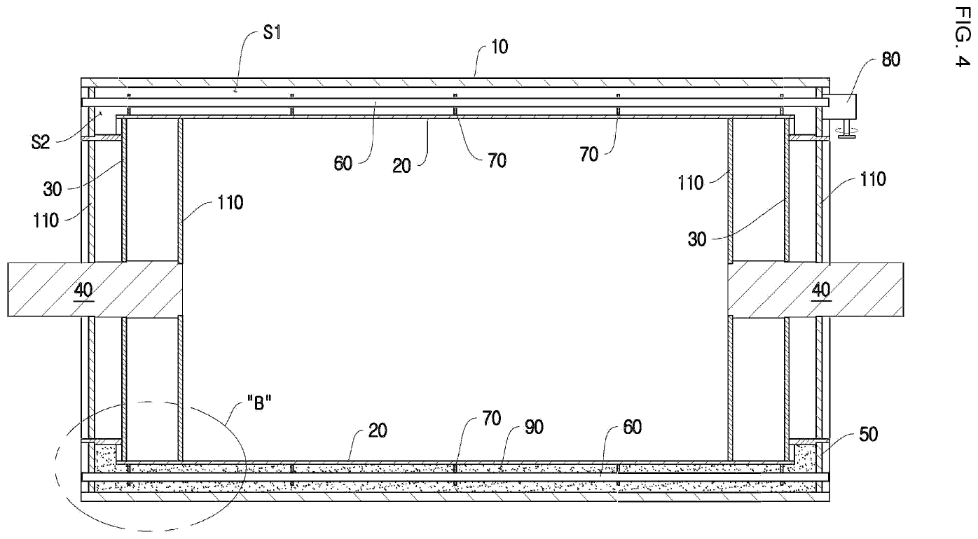

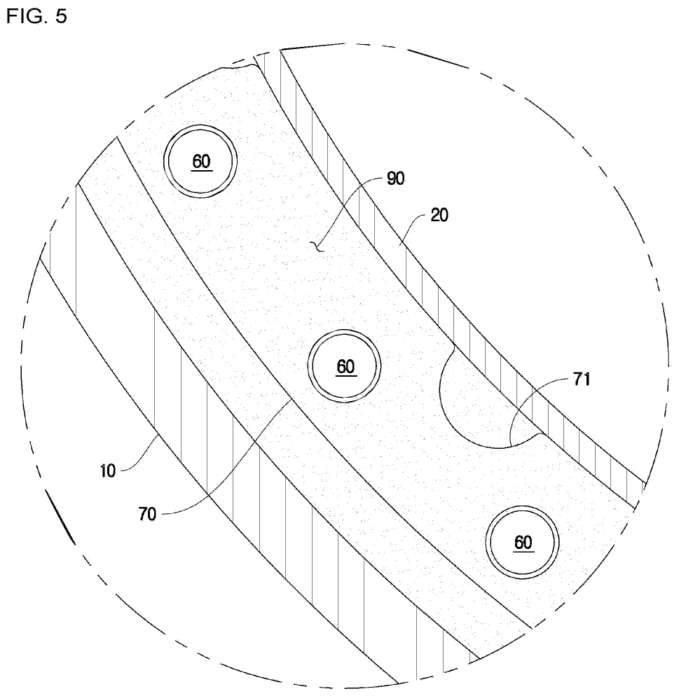

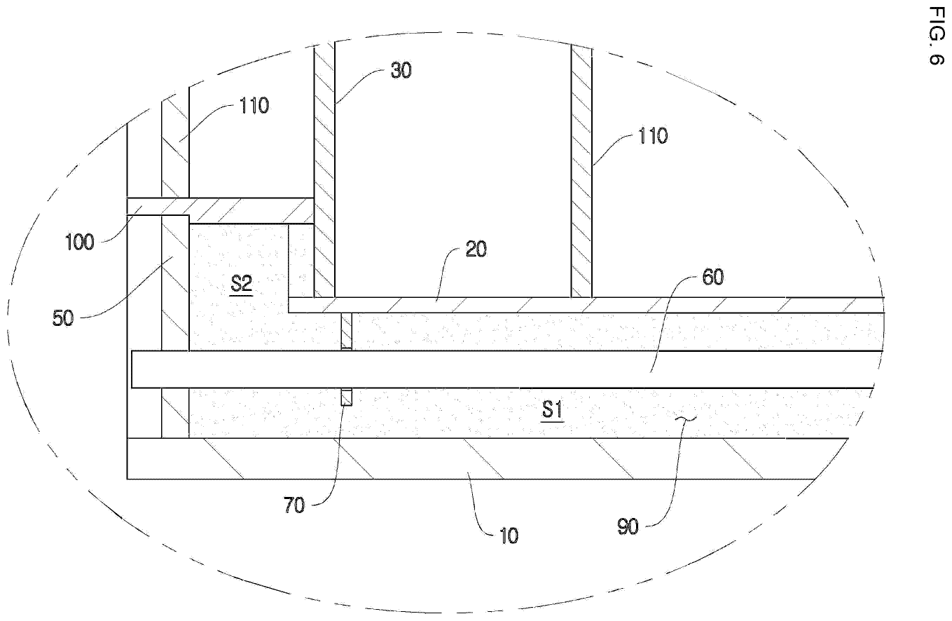

FIG. 1 is a perspective view of a heating drum for thermal transfer according to a first embodiment of the present invention, FIG. 2 is a partial sectional perspective view of FIG. 1, FIG. 3 is a side sectional view of FIG. 1, FIG. 4 is a front sectional view of FIG. 1, FIG. 5 is an enlarged view of portion “A” of FIG. 3, and FIG. 6 is an enlarged view of portion “B” of FIG. 4.

Referring to FIGS. 1 to 6, the heating drum for thermal transfer according to the first embodiment of the present invention is applied to a printing apparatus that heats and prints a predetermined pattern transferred to a print medium such as a fabric. The heating drum for thermal transfer includes an outer tube 10, an inner tube 20, connecting members 30, a rotating shaft 40, covers 50, heaters 60, cradles 70, a valve 80, and heat transfer oil 90.

According to this embodiment, only a portion of the inside of the heating drum is filled with the heat transfer oil 90 and the rest is caused to be in a state of negative pressure lower than atmospheric pressure, so that the heat transfer oil 90 can be stirred. Furthermore, the heat transfer oil 90 is stirred while being directly heated by the heaters 60. This helps to keep the overall temperature of the heating drum uniform, so that the product defect rate attributable to a difference in temperature can be reduced. In addition, the heat transfer oil accommodating space S1 in which the heat transfer oil 90 is accommodated is caused to be in a state of pressure lower than atmospheric pressure. Accordingly, even when the heat transfer oil 90 expands by the heat of the heaters 60, it can be sufficiently absorbed, so that the risk of damage or explosion attributable to a change in pressure can be significantly reduced. Therefore, thin members may be used, so that the compactness and weight reduction of the heating drum can be achieved. Finally, as the heat transfer oil 90 is stored in the heat transfer oil accommodating space S1 in a sealed state, contact with the atmosphere (the outside air) may be fundamentally blocked, so that there is a technical feature in that the oxidation of the heat transfer oil 90 can be prevented.

The outer tube 10 is a cylindrical hollow tube.

The inner tube 20 is disposed inside the outer tube 10, and is a cylindrical hollow tube having a smaller diameter than the outer tube. The connecting members 30 each having a penetrated center are inserted and welded into both ends of the inner tube 20 and one end of the rotating shaft 40 is passed through and welded to a hole formed in the center of each of the connecting members 30, so that the inner tube 20, the connecting members 30, and the rotating shaft 40 form an integrated structure. In this case, the connecting members 30 are media interconnecting the inner tube 20 and the rotating shaft 40, and the connecting members 30 are installed into both ends of the inner tube 20 and serve to support the inner tube 20.

Any known component may be applied as the connecting member 30 described above as long as it can securely fix the inner tube 20 and the rotating shaft 40 to each other.

Although the divided rotating shaft 40 is applied in the present embodiment, a long rod-type rotating shaft 40 may be applied, rather than a divided type shaft, when necessary.

Meanwhile, the covers 50 are fitted over the outer circumferential surfaces of both ends of the inner tube 20, and support the outer tube 10. These covers 50 are disposed between and welded to the outer circumferential surface of the inner tube 20 and the inner circumferential surface of the outer tube 50, so that the inner tube 20, the outer tube 10, and the covers 50 form an integrated structure in a sealed form and a heat transfer oil accommodating space S1 is naturally provided between the inner tube 20, the outer tube 10, and the covers 50. Meanwhile, when necessary, the connecting members 30 and the covers 50 may be fabricated in an integrated structure instead of a divided structure in order to block both ends of the inner and outer tubes 20 and 10 at the same time.

Next, the heaters 60 are installed through the covers 50 and sealed such that no flow occurs at the boundaries between the covers 50 and the heaters 60, and the heaters 60 installed as described above heat the heat transfer oil accommodating space S1. More specifically, the heaters 60 are arranged radially around the rotating shaft 40 at equal intervals. The heaters 60 arranged as described above receive power from the outside, and generate heat. The heat transfer oil 90 filled in the heat transfer oil accommodating space S1 is heated by the heaters 60 that generate heat as described above. The number of heaters 60 may be increased or decreased as needed.

Meanwhile, the ring-shaped holders 70 configured to support the heaters 60 on the outer circumferential surface of the inner tube 20 are arranged and welded at regular intervals between the covers 50. In particular, it is preferable to install the holders 70 so that the top surfaces thereof are spaced apart from the inner circumferential surface of the outer tube 10 by a predetermined distance. The reason for this is to allow the heat transfer oil 90 to flow and be subjected to convection naturally due to a difference in ambient temperature (heat loss increases in the direction toward the outer tube).

For example, when the holders 70 are installed on the inner circumferential surface of the outer tube 10 and spaced apart from the outer circumferential surface of the inner tube 20, the heat of the heaters 60 is transferred directly to the outer tube 10 through the holders 70, so that a difference in temperature occurs.

In addition, when the holders 70 are installed such that both sides (the outer and inner circumferential surfaces) thereof come into contact with the outer circumferential surface of the inner tube 20 and the inner circumferential surface of the outer tube 10, the natural flow of the heat transfer oil 90 is disturbed and the heat of the heaters 60 is transferred directly to the outer tube 10 through the holders 70, so that a difference in temperature occurs.

Meanwhile, communication holes 71 are formed in the holders 70 in an integrated form. These communication holes 71 are disposed adjacent to the outer circumferential surface of the inner tube 20, and serve to allow the heat transfer oil 90 to freely flow into a space partitioned by the holders 70.

Meanwhile, as described above, the pressure of the heat transfer oil accommodating space S1 is in a state of negative pressure lower than atmospheric pressure, and a portion of the heat transfer oil accommodating space S1 is filled with the heat transfer oil 90. To this end, an inlet IP and the faucet-type valve 80 communicating with the heat transfer oil accommodating space S1 are installed on the cover 50 to be exposed from the cover 50. The heat transfer oil 90 is injected through the inlet IP, and the internal air of the heat transfer oil accommodating space S1 is discharged through the valve 80. The inlet IP is closed (blocked) later, so that external air (or heat transfer oil) is not introduced through the inlet IP. Furthermore, in order to cause the inside of the heat transfer oil accommodating space S1 to be in a state of negative pressure lower than atmospheric pressure, the present embodiment is configured such that, in the state in which a vacuum pump (not shown) is connected to the valve 80, the internal air of the heat transfer oil accommodating space S1 is forcibly discharged and then the valve 80 is closed to maintain a negative pressure state.

Meanwhile, the heating drum according to the present invention may be modified and practiced, as shown in FIG. 2.

Referring to FIG. 2, the overall structure is the same as that of the previous embodiment, except that auxiliary tubes 100 are further provided to form a loss compensation space S2 that communicates with the heat transfer oil accommodating space S1.

The auxiliary tubes 100 are fabricated to have a shorter length than the outer tube 10 and the inner tube 20, have a smaller diameter than the inner tube 20, and are disposed and welded onto the connecting members 30 installed at both ends of the inner tube 20 so that the auxiliary tubes 100 can be disposed between the outer tube 10 and the rotating shaft 40. In this case, the connecting members 30 seal both ends of the inner tube 20.

Meanwhile, the covers 50 are fitted and welded between the outer tube 10 and the auxiliary tubes 100, thereby sealing both ends of the outer tube 10. Furthermore, the covers 50 form the loss compensation space S2, communicating with the heat transfer oil accommodating space S1, together with the outer tube 10 and the auxiliary tubes 100. In this case, the loss compensation space S2 is a space for compensating for heat loss.

As an example, the heaters 60 receive power and heat the heat transfer oil 90. In this case, the heat of the heaters 60 is introduced into the heat transfer oil accommodating space S1 and the loss compensation space S2 together with the heated heat transfer oil 90, and forms an air layer while heating both ends of the outer tube 10 and the covers 50.

Accordingly, the outer tube 10 may enable an overall temperature, including the temperature of the edges, to be maintained at a uniform temperature by the heated heat transfer oil 90 and the heat (the heat of the heaters) filled in the heat transfer oil accommodating space S1 and the loss compensation space S2. This has the advantage of being able to mass-produce products with excellent transfer quality by significantly reducing product defects attributable to a difference in temperature.

Meanwhile, there may be a structurally weak point in which each part of the rotating shaft 40 is fixed by only the single connecting member 30. Accordingly, in the present embodiment, the above problem is overcome by installing reinforcing plates 110 capable of supporting the part of the rotating shaft 40 together with the connecting member 30.

The reinforcing plates 110 are circular plates each having a penetrated center. The reinforcing plates 110 are disposed and welded onto the inner circumferential surface of the inner tube 20 and the inner circumferential surface of the auxiliary tube 100, respectively, with the connecting member 30 interposed therebetween. The reinforcing plates 110 are spaced apart from the connecting member 30, and the part of the rotating shaft 40 is inserted and welded into holes formed in the centers thereof.

As described above, there is an advantage in that the overall mechanical strength (rigidity) can be supplemented by further disposing the reinforcing plates 110 for supporting the rotating shaft 40 inside the inner tube 20 or the auxiliary tube 100.

A method of manufacturing a heating drum for thermal transfer according to the present invention will be described as follows:

### (1) Heating Drum Manufacturing Step St1

In the heating drum manufacturing step St1, the inner tube 20 having a smaller diameter than the outer tube is disposed inside the cylindrical outer tube 10, the rotating shaft 40 is located through the center of the inner tube 20 via the connecting members 30, the covers 50 having the inlet IP are installed between the inner tube 20 and the outer tube 10 and perform sealing so that the heat transfer oil accommodating space S1 can be formed in the space between the inner tube 20 and the outer tube 10, the heaters 60 are installed to penetrate the covers 50 in order to heat the heat transfer oil accommodating space S1, the holders 70 for supporting the heaters 50 are installed between the inner tube 20 and the outer tube 10, and the valve 80 for controlling the discharge of the internal air of the heat transfer oil accommodating space S1 is installed in one of the covers 50.

Furthermore, stirring blades 21 may be installed on the outer circumferential surface of the inner tube 20, in which case the heaters 60 are located between the inner circumferential surface of the outer tube 10 and the top surfaces of the stirring blades 21.

### (2) Injection and Closing Step St2

In the injection and closing step St2, the heat transfer oil 90 is injected through the inlet IP formed in the cover 50 so that a portion of the heat transfer oil accommodating space S1 is filled with the heat transfer oil 90, the internal air of the heat transfer oil accommodating space S1 is allowed to be discharged through the valve 80, and then the inlet IP is closed.

### (3) Negative Pressure Forming Step St3

In the negative pressure forming step St3, in a state in which a vacuum pump (not shown) is connected to the valve 80, the internal air of the heat transfer oil accommodating space S1 is forcibly discharged and then the valve 80 is closed so that the inside of the heat transfer oil accommodating space S1 can be maintained in a state of negative pressure lower than atmospheric pressure.

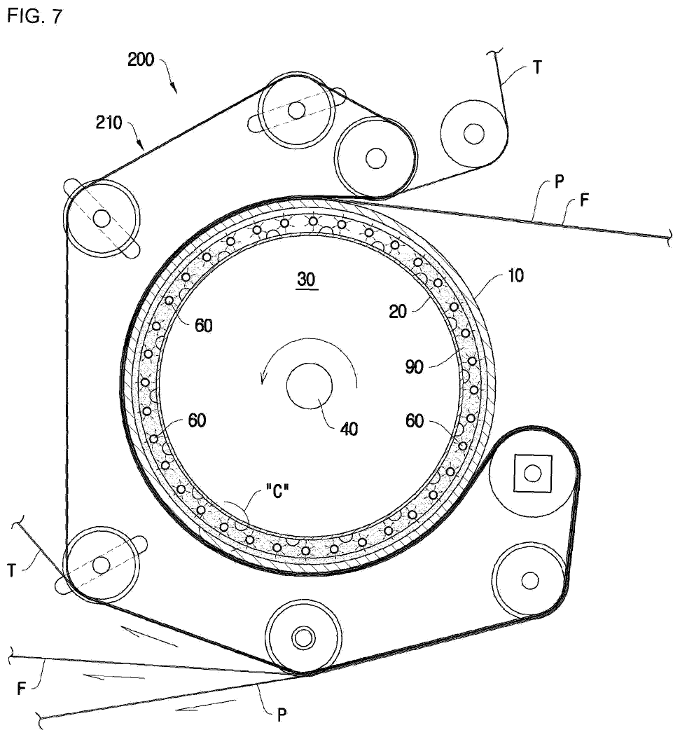

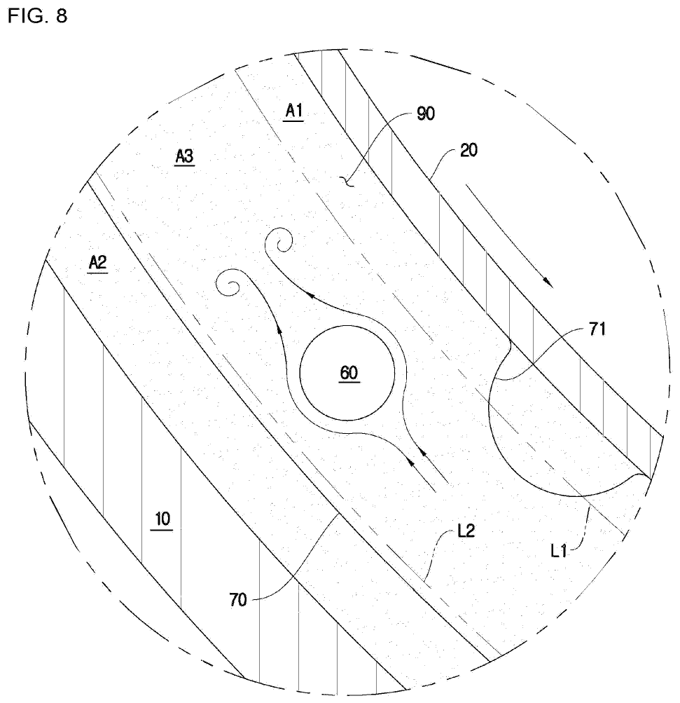

FIGS. 7 and 8 are views illustrating the operation of the heating drum for thermal transfer according to the first embodiment of the present invention. In more detail, FIG. 7 is a view illustrating thermal transfer using the heating drum of the present invention, and FIG. 8 is an enlarged view of “C” of FIG. 7. A description will be given with reference to these drawings as follows:

The heating drum according to the present invention may be applied to the known heat transfer unit disclosed in Korean Patent No. 10-1968314.

As shown in 7, the heating drum according to the present invention is rotated by a close contact mechanism 210 constituting a part of a heat transfer unit 200, and the heaters 60 constituting a part of the heating drum receive power and generate heat.

In addition, as a transfer paper P, a fabric F, and a tissue T are drawn in between the heating drum and the close contact mechanism driven as described above and are then pressed (compressed) and subjected to heat at the same time, the print of the transfer paper P is transferred to the fabric F and the fed materials are then discharged.

Meanwhile, the heat transfer oil 90 is stirred while the heaters 60 directly heat the heat transfer oil 90 accommodated in the heat transfer oil accommodating space S1 and the loss compensation space S2. The heat transfer oil 90 stirred and heated as described above uniformly heats the outer tube 10. Accordingly, the print medium P moving in close contact with the outer tube 10 may be heated to a uniform temperature.

Accordingly, the outer tube 10 allows an overall temperature, including the temperature of the edges, to be always maintained at a uniform temperature by the heated heat transfer oil 90 and the heat (the heat of the heaters) filled in the heat transfer oil accommodating space S1 and the loss compensation space S2. This may enable products with excellent transfer quality to be mass-produced by significantly reducing product defects attributable to a difference in temperature.

In particular, the present invention helps to keep the overall temperature of the heating drum uniform as the heat transfer oil 90 is directly heated by the heaters 60 and stirred, so that the product defect rate attributable to a difference in temperature can be reduced.

In addition, the heat transfer oil accommodating space S1 and the loss compensation space S2, in which the heat transfer oil 90 is accommodated, are caused to be in a state of pressure (a state of negative pressure) lower than atmospheric pressure, so that expansion can be sufficiently absorbed even when the heat transfer oil 90 is expanded by the heat of the heaters 60, with the result that the risk of damage or explosion of the heating drum attributable to a change in pressure may be significantly reduced. Accordingly, in the manufacture of the heating drum, thin members may be used, so that the compactness and weight reduction of the heating drum can be achieved.

Finally, as the heat transfer oil 90 is stored in the heat transfer oil accommodating space S1 and the loss compensation space S2 in a sealed state, contact with the atmosphere (the outside air) may be fundamentally blocked, so that the oxidation of the heat transfer oil 90 can be prevented. Accordingly, the heat transfer oil 90 may be used semi-permanently.

Meanwhile, as shown in FIG. 8, the heat transfer oil 90 is stirred while the heater 60 is rotated. In an area A3 (an area which is provided between a first boundary line L1 and a second boundary line L2 and through which the heaters pass), a vortex is generated to the extent that the heat transfer oil 90 is mixed. In contrast, in an area A1 which is located between the inner tube 20 and the first boundary line L1 or an area A2 which is located between the outer tube 10 and the second boundary line L2, the transmission of a vortex attributable to the stirring of the heaters 60 is considerably insignificant, so that there is a problem in that mixing does not occur smoothly.

Therefore, it should be noted that in the present embodiment, an inner tube 20 is provided with stirring blades 21 in a supplementary manner, so that the above-described problem can be overcome.

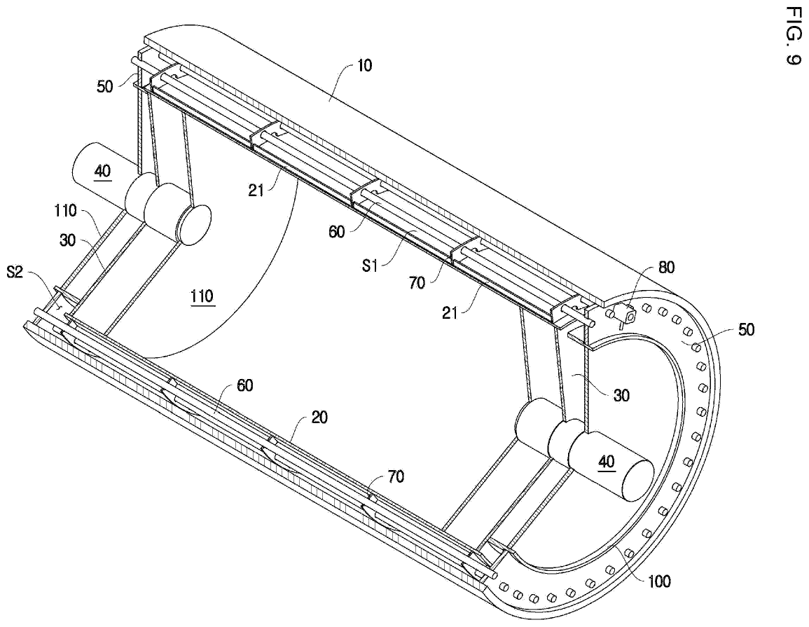

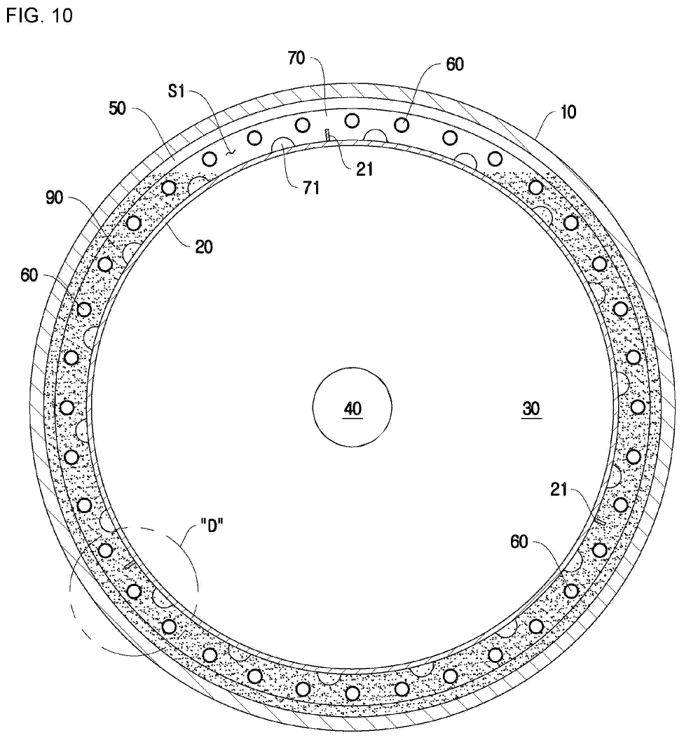

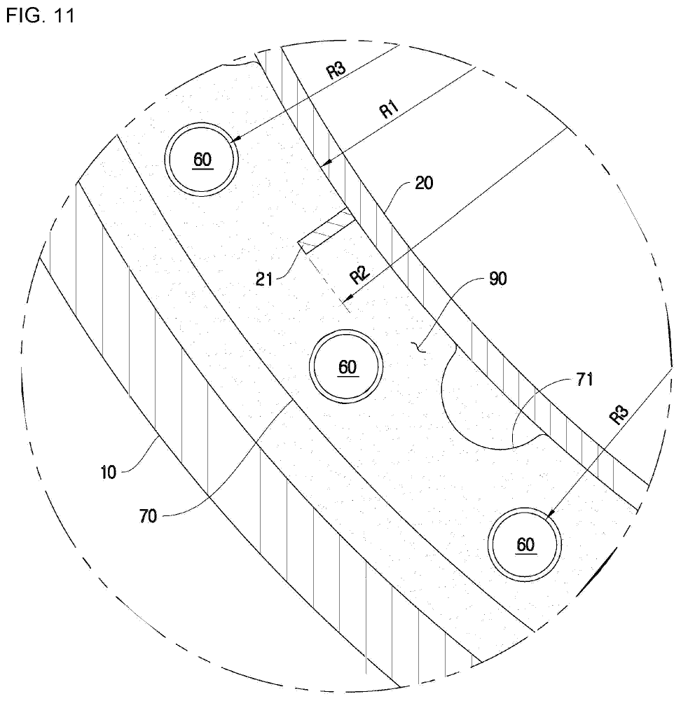

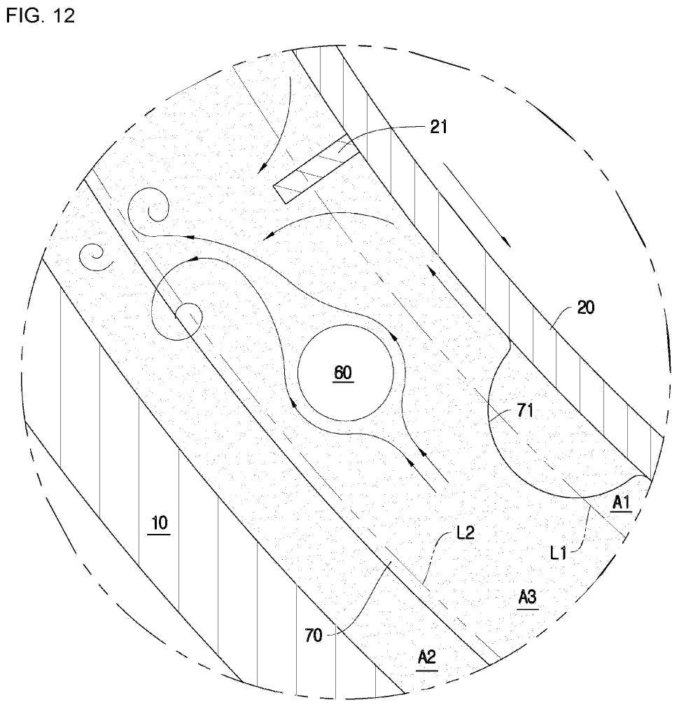

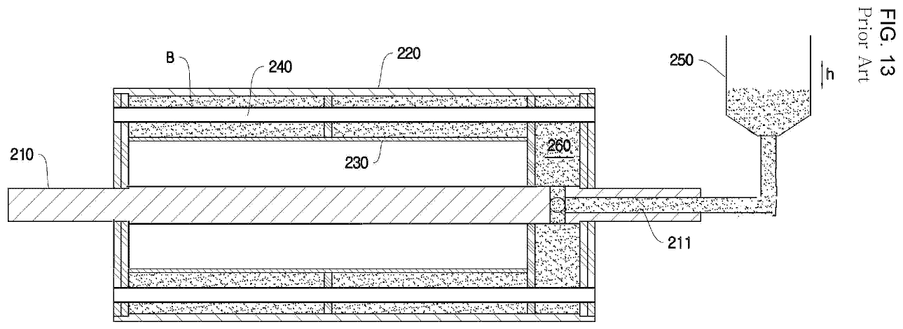

FIGS. 9 to 11 are views showing a heating drum to which stirring blades are applied. FIG. 9 is a partial sectional perspective view of a heating drum for thermal transfer according to a second embodiment of the present invention, FIG. 10 is a side sectional view of the heating drum for thermal transfer according to the second embodiment of the present invention, FIG. 11 is an enlarged view of portion “D” of FIG. 10, and FIG. 12 is a view illustrating the operation of the heating drum for thermal transfer according to the second embodiment of the present invention.

The overall structure of the heating drum for heat transfer according to the second embodiment of the present invention is the same as that of the first embodiment, except that the inner tube 20 is provided with the stirring blades 21 in a supplementary manner.

The stirring blades 21 are formed on the outer circumferential surface of the inner tube 20, and serve to stir the heat transfer oil 90 together with the heaters 60.

As shown in FIG. 10, the stirring blades 21 are radially arranged at intervals of 120° around the rotating shaft 40, and the number of stirring blades 21 may be increased or decreased as needed.

Referring to FIG. 11, R1 is the linear distance from the center of the inner tube 20 to the outer circumferential surface thereof, R2 is the distance from the center of the inner tube 20 to the ends of the stirring blades 21, and R3 is the linear distance from the center of the inner tube 20 to the heaters 60. It is preferable that the length (or height) R2 of the stirring blades 21 is formed to be larger than R1 and to be smaller than R3.

Referring to FIG. 12, in the case where the length (or height) R2 of the stirring blades 21 is formed to be R1<R2<R3 as described above, as the heat transfer oil 90 is stirred while the heaters 60 are rotated, a vortex is generated in the area A3 (the area through which the heaters pass) located between the first boundary line L1 and the second boundary line L2. In the process in which the stirring blades 21 are rotated, the heat transfer oil 90 of the area A1 located between the inner tube 20 and the first boundary line L1 is pushed into the area A3 (the area through which the heaters pass) by the stirring blades 21. Accordingly, a vortex generated in the area A3 (the area through which the heaters pass) is naturally pushed into the area A2 located between the outer tube 10 and the second boundary line L2, and is rapidly mixed with the heat transfer oil 90 of the area A2.

In other words, when the stirring blades 21 are not applied, the mixing of the heat transfer oil 90 is considerably insignificant in the area A1 or area A2, so that it is difficult to expect smooth flow and stirring activities.

In contrast, when the stirring blades 21 are applied, the heat transfer oil 90 is mixed by the stirring blades 21 in the area A1, and is also mixed by the stirring blades 21 and the heaters 60 in the area A2, so that the heat transfer oil 90 can be stirred throughout the overall range thereof. This can help to maintain the overall temperature of the heating drum rapidly, smoothly and uniformly. Accordingly, the product defect rate attributable to a difference in temperature may be significantly reduced.

Although the present invention has been described in detail only in conjunction with the specific embodiments described, it is apparent to those skilled in the art that various alterations and modifications may be made within the technical spirit of the present invention, and also it is apparent that such alterations and modifications fall within the scope of the appended claims.

The invention claimed is:

1. A heating drum for thermal transfer, the heating drum comprising:
a cylindrical outer tube;
an inner tube having a smaller diameter than the outer tube, and disposed inside the outer tube;
a rotating shaft fixed to a center of the inner tube via connecting members;
covers configured to form a heat transfer oil accommodating space by sealing a space between the inner tube and the outer tube that is opened to an outside;
heaters installed to pass through the covers, and configured to heat the sealed heat transfer oil accommodating space;
holders disposed between the inner tube and the outer tube, and configured to support the heaters;
a valve configured to control discharge of internal air of the heat transfer oil accommodating space; and
heat transfer oil filled in the heat transfer oil accommodating space;
wherein the heat transfer oil is partially filled in the heat transfer oil accommodating space, and the internal air of the heat transfer oil accommodating space is forcibly discharged through the valve so that internal pressure of the heat transfer oil accommodating space is maintained at a pressure lower than atmospheric pressure.

2. The heating drum of claim 1, wherein:
stirring blades are provided on an outer circumferential surface of the inner tube in a supplementary manner; and
the heaters are located between an inner circumferential surface of the outer tube and top surfaces of the stirring blades.

3. The heating drum of claim 1, wherein the holders are installed on the inner tube to be spaced apart from an inner circumferential surface of the outer tube.

4. The heating drum of claim 3, wherein the holders are provided with communication holes in a supplementary manner.

5. The heating drum of claim 1, wherein:
a length of the outer tube is formed to be longer than a length of the inner tube;
the inner tube is sealed by the connecting members;
auxiliary tubes having a smaller diameter than the inner tube are provided on the connecting members in a complementary manner, and are disposed between the outer tube and the rotating shaft; and
the covers are inserted between the outer tube and the auxiliary tubes, and form a loss compensation space communicating with the heat transfer oil accommodating space while sealing both ends of the outer tube.

6. The heating drum of claim 5, wherein reinforcing plates configured to support the inner tube and the auxiliary tubes are provided in the inner tube and the auxiliary tubes with the connecting members interposed therebetween.

7. A method of manufacturing a heating drum for thermal transfer, the method comprising:
a heating drum manufacturing step (St1) of disposing an inner tube having a smaller diameter than a cylindrical outer tube inside the outer tube, locating a rotating shaft through a center of the inner tube via connecting members, installing covers having an inlet between the inner tube and the outer tube and performing sealing so that a heat transfer oil accommodating space can be formed in a space between the inner tube and the outer tube, installing heaters to penetrate the covers in order to heat the heat transfer oil accommodating space, installing holders for supporting the heaters between the inner tube and the outer tube, and installing a valve for controlling discharge of internal air of the heat transfer oil accommodating space in one of the covers;
an injection and closing step (St2) of injecting heat transfer oil through the inlet formed in the cover so that a portion of the heat transfer oil accommodating space is filled with the heat transfer oil, allowing the internal air of the heat transfer oil accommodating space to be discharged through the valve, and then closing the inlet; and
a negative pressure forming step (St3) of, in a state in which a vacuum pump is connected to the valve, forcibly discharging the internal air of the heat transfer oil accommodating space, and then closing the valve so that an inside of the heat transfer oil accommodating space can be maintained in a state of negative pressure lower than atmospheric pressure.

8. The method of claim 7, wherein, in the heating drum manufacturing step (St1), stirring blades are installed on an outer circumferential surface of the inner tube so that the heaters are located between an inner circumferential surface of the outer tube and top surfaces of the stirring blades.

9. The heating drum of any one of claim 2, wherein:
a length of the outer tube is formed to be longer than a length of the inner tube;
the inner tube is sealed by the connecting members;
auxiliary tubes having a smaller diameter than the inner tube are provided on the connecting members in a complementary manner, and are disposed between the outer tube and the rotating shaft; and
the covers are inserted between the outer tube and the auxiliary tubes, and form a loss compensation space communicating with the heat transfer oil accommodating space while sealing both ends of the outer tube.

10. The heating drum of claim 9, wherein reinforcing plates configured to support the inner tube and the auxiliary tubes are provided in the inner tube and the auxiliary tubes with the connecting members interposed therebetween.

11. The heating drum of any one of claim 3, wherein:
a length of the outer tube is formed to be longer than a length of the inner tube;
the inner tube is sealed by the connecting members;
auxiliary tubes having a smaller diameter than the inner tube are provided on the connecting members in a complementary manner, and are disposed between the outer tube and the rotating shaft; and
the covers are inserted between the outer tube and the auxiliary tubes, and form a loss compensation space communicating with the heat transfer oil accommodating space while sealing both ends of the outer tube.

12. The heating drum of claim 11, wherein reinforcing plates configured to support the inner tube and the auxiliary tubes are provided in the inner tube and the auxiliary tubes with the connecting members interposed therebetween.

13. The heating drum of any one of claim 4, wherein:
a length of the outer tube is formed to be longer than a length of the inner tube;
the inner tube is sealed by the connecting members;
auxiliary tubes having a smaller diameter than the inner tube are provided on the connecting members in a complementary manner, and are disposed between the outer tube and the rotating shaft; and
the covers are inserted between the outer tube and the auxiliary tubes, and form a loss compensation space communicating with the heat transfer oil accommodating space while sealing both ends of the outer tube.

14. The heating drum of claim 13, wherein reinforcing plates configured to support the inner tube and the auxiliary tubes are provided in the inner tube and the auxiliary tubes with the connecting members interposed therebetween.
